(19) United States
(12) Patent Application Publication
(10) Pub. No.: US 2022/0065358 A1
(43) Pub. Date: Mar. 3, 2022

(54) POPPET VALVE

(71) Applicant: BURCKHARDT COMPRESSION AG, Winterthur (CH)

(72) Inventor: Reiner SCHULZ, Lottstetten (DE)

(73) Assignee: BURCKHARDT COMPRESSION AG, Winterthur (CH)

(21) Appl. No.: 17/416,690

(22) PCT Filed: Dec. 23, 2019
(86) PCT No.: PCT/EP2019/086995

§ 371 Date: Jun. 21, 2021

(30) Foreign Application Priority Data
Dec. 21, 2018 (EP) 18215193.6

(51) Int. Cl. F16K 15/02; F16K 27/02; F16K 27/00

(52) U.S. Cl. CPC F16K 15/026; F04B 39/1013; F16K 27/003; F16K 27/0209

(57) ABSTRACT

The poppet valve including a valve body with a plurality of passage channels, a plurality of closing elements, a plurality of guide means, and a catcher. Each passage channel opening into a valve seat. A closing element is mounted on each guide means movable in a stroke direction. A closing element is associated with each valve seat opposite in the stroke direction, so that valve seats can be closed by the closing elements. Guide means are connected to the catcher, each having a guide section with an inner cavity extending in the stroke direction and a support section bearing surface. The spring extends in the inner cavity of the guide section and is clamped between the bearing surface and the closing element. Guide means have a first stop surface towards the valve seat, closing elements have a second stop surface towards the first stop surface to limit closing element travel.

### DESCRIPTION

The invention relates to a poppet valve according to the preamble of claim 1.

### STATE OF THE ART

U.S. Pat. No. 4,489,752 discloses a poppet valve for a piston compressor. This poppet valve exhibits relatively high wear and relatively high flow resistance. In addition, the valve behaves relatively sluggishly when opening and closing. In addition, both the manufacturing costs and the maintenance costs of the Poppet valve are relatively high. There is thus a need for a more efficient, less expensive, lower-maintenance and/or easier-to-maintain poppet valve.

### PRESENTATION OF THE INVENTION

It is the object of the invention to provide an economically more advantageous poppet valve for a piston compressor.

This object is solved with a poppet valve having the features of claim 1. Dependent claims 2 to 25 relate to further, advantageous embodiments of the invention.

The object is solved in particular with a poppet valve comprising a valve body with a plurality of passage channels, a plurality of closing elements, a plurality of guide means, as well as a catcher, wherein each passage channel opens into a valve seat, wherein on each guide means in each case a closing element is mounted movably in a stroke direction, wherein in each case a closing element is assigned to each valve seat lying opposite in the stroke direction, so that each valve seat can be closed by the respectively assigned closing element, wherein the guide means are connected to the catcher, wherein each guide means comprises a guide section with an inner cavity extending in the stroke direction and a support section comprising a bearing surface, wherein the spring extends in the inner cavity of the guide section and is clamped between the bearing surface and the closing element, wherein each guide means has a first stop surface oriented toward the valve seat, wherein each closing element has a second stop surface oriented toward the first stop surface, and wherein the first and second stop surfaces are arranged to cooperate so as to limit the maximum stroke of the closing element in the stroke direction.

The object is further solved in particular with a poppet valve comprising a valve body with a plurality of passage channels, a plurality of closing elements, a plurality of guide means, as well as a catcher, wherein each passage channel opens into a valve seat, wherein on each guide means in each case a closing element is mounted movably in a stroke direction, wherein a respective closing element is associated with each valve seat opposite in the stroke direction, so that each valve seat can be closed by the respectively associated closing element, wherein each guide means comprises, following one another in the stroke direction, a guide section, a support section and a fastening section, wherein each guide means is connected to the catcher via the fastening section, wherein the guide section comprises an inner cavity extending in the direction of the stroke, and wherein the support section comprises a bearing surface, wherein a spring extending in the inner cavity of the guide section is clamped between the bearing surface and the closing element, and wherein the guide means comprises a single guide section extending in the direction of the stroke, each guide means comprising a first stop surface directed towards the valve seat wherein each closing element has a second stop surface directed towards the first stop surface, wherein the first and second stop surfaces are arranged to cooperate in such a way that they limit the maximum stroke of the closing element in the stroke direction, and wherein the fastening section forms a positive connection to the catcher acting in both directions of the stroke direction. A positive connection is understood to mean a connection that is formed by the interlocking of at least two connection partners. As a result, the connecting partners cannot become detached even without or in the event of interrupted force transmission.

The poppet valve according to the invention has the advantage that the closing element no longer strikes directly against the catcher, which reduces the wear of the closing element as well as the wear of the catcher. The poppet valve according to the invention comprises a guide means with a first stop surface as well as a closing element with a second stop surface, wherein the two stop surfaces are arranged adapted to each other in such a way that they limit the maximum stroke of the closing element. In addition, this design has the consequence that during operation of the poppet valve mainly the guide means and the closing element are subject to wear, whereby the guide means as well as the closing element can advantageously be replaced in a simple manner. The Poppet valve according to the invention also has the advantage that its closing elements can be designed with relatively low mass. This reduces the forces occurring during braking of the closing element, in particular the forces acting on the valve body, and the forces acting on the catcher. On the one hand, these reduced forces result in less wear of the closing element, valve body and/or guide means, and preferably also make it possible to design the valve body and/or the catcher with lower mass and/or with lower rigidity. Thus, it is possible to provide the valve body and/or the catcher with a plurality and/or a plurality of passage openings, and still ensure a sufficiently large stiffness and a long-term reliable operation of the poppet valve. A separate closing element is associated with each passage opening of the valve body. The poppet valve according to the invention has the further advantage that it can have a plurality of passage openings and closing elements. In an advantageous embodiment, the poppet valve according to the invention comprises between 10 and 50 passage openings as well as the same number of closing elements, and particularly preferably between 20 and 40 passage openings or closing elements. This relatively high number of passage openings and closing elements has the advantage that the passage openings as well as the closing elements have a relatively small diameter, which on the one hand reduces the mass of the closing element, and which on the other hand distributes the fluid flow flowing through the poppet valve more evenly over the face of the poppet valve, thus reducing the flow resistance of the poppet valve. Closing elements with a low mass also have the advantage that they react very quickly in accordance with the applied forces and are moved in the stroke direction, so that the poppet valve according to the invention has a short reaction time of the closing elements.

The poppet valve according to the invention comprises guide means, each guide means having a fastening section which is fastened to the catcher, or can be fastened to the catcher, forming a positive connection acting in both directions of the stroke direction. This positive connection ensures that the guide means is securely fastened to the catcher.

Advantageously, the catcher has a constant width in the stroke direction. Advantageously, the catcher consists of a tabular material, preferably with a thickness in the range of 3 to 6 mm, particularly advantageously in the range of 4 to 5 mm. Particularly advantageously, the catcher consists of a metallic sheet.

The fastening section is advantageously designed as a snap-in connecting part, particularly advantageously as a detachable snap-in connecting part, so that the guide means can be easily detached from the catcher and preferably replaced by a new guide means. The guide means and preferably also the closing element are preferably designed as spare parts so that they can be easily replaced after a certain period of time and/or in the event of wear.

The poppet valve according to the invention comprises a separate, associated closing element for each passageway as well as a guide means associated with each closing element, which guides the respective closing element in the stroke direction. In a particularly advantageous embodiment, the closing elements and the guiding means are easily replaceable, and advantageously also individually replaceable, so that during maintenance either all closing elements and/or all guiding means are easily replaced, or that during maintenance only those closing elements and/or guiding means are replaced which should be replaced according to the existing wear.

Advantageously, the guide means are detachably connected to the catcher in a simple manner, for example via a clip connection or a snap-in connection, so that the guide means can be detached from the catcher and replaced in a simple manner during maintenance.

Each closing element is movably guided in the stroke direction by the associated guide element. In an advantageous design, the closing element encloses the guide element from the outside, so that the guide element is at least partially arranged inside the closing element in the stroke direction. This design has the advantage, for example, that hardly any dirt deposits are formed on the guide element, which could result from dirt particles of the fluid flowing through. In a further, advantageous embodiment, the guide element encloses the closing element from the outside, so that the closing element is arranged at least partially inside the guide element in the stroke direction. This embodiment has the advantage, for example, that the closing element can be made of a plastic, the plastic preferably being selected in such a way that it causes little wear when it strikes the valve body or the valve seat. In an advantageous embodiment, a material pairing of the valve seat and the closing element is selected such that the closing element wears much more than the valve seat during operation of the poppet valve, for example, in that the closing element is made of a plastic, and the valve seat or the valve body is made of a metal. Since the closing element is easily and inexpensively replaceable, this embodiment ensures long-term reliable and inexpensive operation of the poppet valve.

The invention is described in detail below by means of examples of embodiments.

### BRIEF DESCRIPTION OF THE DRAWINGS

The drawings used to explain the embodiments show:

FIG. 1a a perspective longitudinal section of a first embodiment of a poppet valve;

FIG. 2a a perspective bottom view of the poppet valve according to FIG. 1;

FIG. 3 a detailed view of the poppet valve according to FIG. 1 but without spring;

FIG. 4 the view according to FIG. 3, but without closing element and valve body;

FIG. 5 the closing element according to FIG. 3;

FIG. 6 a perspective longitudinal section through a second embodiment of a poppet valve;

FIG. 7 a perspective bottom view of the poppet valve according to FIG. 6;

FIG. 8 a detailed view of the poppet valve according to FIG. 6;

FIG. 9 the view according to FIG. 8, but without closing element, spring and valve body;

FIG. 10 the closing element according to FIG. 8;

FIG. 11 a front view of the closing elements of the poppet valve according to FIG. 6.

In principle, the same parts are given the same reference signs in the drawings.

### WAYS TO CARRY OUT THE INVENTION

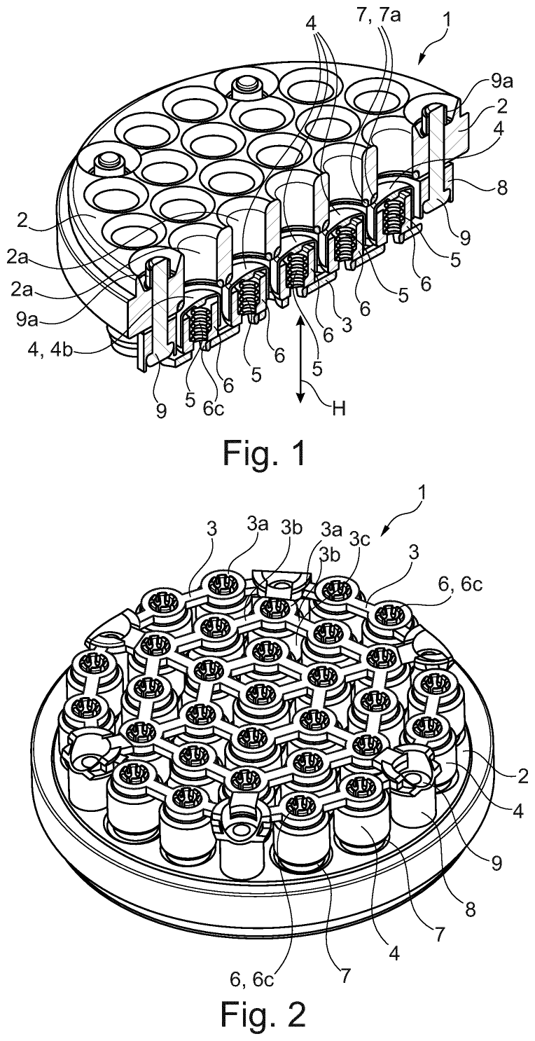

FIG. 1 shows a perspective longitudinal section of a first embodiment of a poppet valve 1. The poppet valve 1 comprises a valve body 2 with a plurality of passage channels 2a, each of which opens into a valve seat 7. Opposite the valve seats 7, a respective closing element 4 movable in stroke direction H is arranged, wherein each of the closing elements 4 comprises a closing head 4b which seals the respective valve seat 7 or the respective passage channel 2a when the closing head 4b is in contact with the valve seat 7. The closing elements 4 are each mounted movably in the stroke direction H via a guide means 6. Each guide means 6 is connected to a catcher 3, the catcher 3 being firmly connected to the valve body 2 via a spacer 8 and a fastening means 9 with nut 9a, so that the catcher 3 and thus also the guide means 6 and the closing elements 4 are arranged in a defined position with respect to the valve body 2, namely in such a way that the closing elements 4 can open or close the respective valve seat 7 opposite in the stroke direction H by a corresponding movement in the stroke direction H. The valve seat 7 can be opened or closed by the closing elements 4. In the illustrated embodiment example, the valve seat 7 comprises an annular valve seat part 7a, which is arranged and configured in such a way that the closing element 4 comes into contact exclusively with the valve seat part 7a during closing. The valve seat part 7a is preferably designed as a wear part, so that the valve seat parts 7a arranged in the valve seat 7 can be replaced, in particular if an occurred wear requires this. The valve seat parts 7a are preferably made of a plastic, for example PTFE, PEEK, FFKM or also of a soft metal alloy, for example a copper or indium alloy. A spring 5 is arranged in each combination of closing elements 4 and guide means 6. The spring is arranged running inside the guiding means 6, as shown in FIG. 1, and causes a biasing force on the closing elements 4 directed towards the valve body 2, so that the closing elements 4 are in contact with the valve seat 7a or the valve body 2 in a resting state of the poppet valve 1. FIG. 1 shows the poppet valve 1 in an open state, in which a fluid flows from top to bottom through the valve body 2, and the closing elements 4 are therefore lifted off the valve seat 7a.

FIG. 2 shows a bottom perspective view of the poppet valve 1 shown in FIG. 1. The catcher 3 is designed as a lattice structure comprising lattice nodes 3a, struts 3b and gaps 3c. Advantageously, as shown in FIG. 2, a single guide means 6 is attached to each lattice node 3a. In a preferred embodiment, the lattice structure of the catcher 3 has relatively large-area gaps 3c, which results in a low flow resistance of the catcher 3. The catcher 3 is fixed at a defined distance and in a defined position with respect to the valve body 2 via a spacer 8 and a fastening means 9. The catcher 3 is preferably made of metal or plastic.

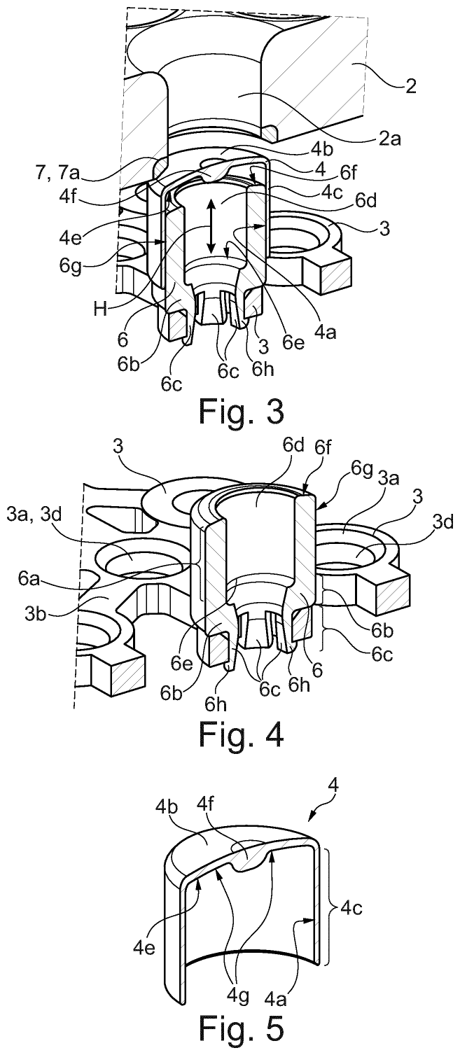

FIG. 3 shows a detailed view of a single closing element 4 and the associated guide means 6 and shows the associated passage 2a of the valve body 2. The spring 5 located in the inner cavity 6d is not shown in order to make the other elements more visible. FIG. 3 does not show the same section as FIG. 1.

The valve body 2 comprises the passage channel 2a and the valve seat 7 with annular valve seat part 7a. A closing element 4 is mounted on each guide means 6 so as to be movable in the stroke direction H. The respective closing element 4 is assigned to each valve seat 7 opposite in stroke direction H. Each valve seat 7 can be closed by the respectively associated closing element 4, the guide means 6 being connected to the catcher 3. Each guide means 6 comprises a guide section 6a, a support section 6b and an fastening section 6c. The guide section 6a comprises an inner cavity 6d extending in the stroke direction H. The support section 6b comprises a bearing surface 6e, wherein the spring 5 shown only in FIG. 1 extends in the inner cavity 6d of the guide section 6a and is clamped between the bearing surface 6e and the closing head 4b of the closing element 4. The guide means 6 has a first stop surface 6f oriented toward the valve seat 7, and the closing element 4 has a second stop surface 4e oriented toward the first stop surface 6f. The first and second stop surfaces 6f, 4e are arranged to cooperate in such a way that they limit the maximum stroke of the closing element 4 in the stroke direction H. The height of the closing element 4 in stroke direction H is selected in such a way that the closing element 4 strikes the guide means 6 only at the top, with its stop surface 4e, whereby the guide member 4c does not come into direct contact with the catcher 3 in any position possible for the closing element 4, so that the closing element 4 also does not strike the catcher 3. This has the advantage that the catcher 3 is subject to no or negligible wear caused by the closing element 4.

In an advantageous embodiment, the closing element 4, as shown in FIGS. 1 and 3, comprises a hollow-cylindrical guide member 4c and a closing head 4b, the closing element 4 being of one-piece design and preferably consisting of a deep-drawn metal. Advantageously, the guide means 6 has a cylindrical, outwardly oriented first sliding surface 6g. The guide member 4c has a cylindrical, inwardly oriented second sliding surface 4a. The closing element 4 and the guide means 6 are designed to be identical in such a way that the first sliding surface 6g and the second sliding surface 4a form mutual sliding surfaces along which the closing element 4 is mounted so that it can slide back and forth in the stroke direction H relative to the guide means 6.

The closing element 4 is preferably designed in one piece, the closing element 4 comprising the closing head 4b as well as the hollow-cylindrical guide section 4c extending adjacent to the closing head 4b in the stroke direction H, the closing head 4b comprising the second stop surface 4e on the side facing away from the valve seat 7. The guide section 6a has an end face oriented towards the valve body 2, which forms the first stop surface 6f.

FIG. 4 shows a part of the catcher 3 and a single guide means 6 connected to the catcher 3 in detail. The catcher 3 is designed as a lattice structure comprising lattice nodes 3a, struts 3b and openings 3d in the lattice nodes 3a. In an advantageous embodiment, the guide means 6 comprises a fastening section 6c, by means of which the guide means 6 can be fastened to the catcher 3, and is preferably also detachable again.

In an advantageous embodiment, the fastening section 6c, as shown in FIGS. 3 and 4, comprises a plurality of clip or snap-in connecting members 6h, each having a barb, so that the fastening section 6c can be inserted into the circular opening 3d of the lattice node 3a, and the barbs abut the catcher 3, so that the guide means 6 is firmly, and preferably releasably, connected to the catcher 3.

FIG. 5 shows the closing element 4 already shown in detail in FIG. 3. In an advantageous embodiment, the guide member 4c, which forms the second sliding surface 4a, extends along the entire height of the closing element 4. In FIGS. 3 and 4, the spring 5, which is in itself required for the closing element 4, is not shown. The guide means 6 comprises a bearing surface 6e against which, as shown in FIG. 1, one end of the spring 5 rests, the other end of the spring 5 resting against the inside of the closing head 4b, preferably against a bearing surface 4g, thereby causing a biasing force to act on the closing element 4 towards the valve body 2. Advantageously, the closing element 4 comprises a projecting centering part 4f, which centers the position of the spring 5 with respect to the closing head 4b. The closing element 4 is preferably very light in design, and for example has a weight in the range of 1 to 20 grams. In an advantageous embodiment, the closing element 4 is made of a metal. Particularly advantageously, the closing element 4 is manufactured from a sheet metal by deep drawing, the sheet metal preferably having a thickness in the range of 0.25 to 1.5 mm. The metallic closing element 4 preferably has a wall thickness in the range from 0.25 to 1.5 mm, and particularly preferably a wall thickness in the range from 0.3 to 1 mm. The metallic closing element 4 preferably has a weight in the range between 5 and 15 grams, and preferably a weight in the range between 8 and 12 grams. Such a closing element 4 can be manufactured at extremely low cost. Such a lightweight closing element 4 has a low inertia, and can therefore be moved very quickly. The closing element 4 could also be made of a plastic. The closing element preferably has a diameter in the range of 8 mm to 15 mm, and in particular a diameter in the range of 10 to 12 mm. The first stop surface 6f has a width radially to the stroke direction H that is preferably at least twice as large as the wall thickness of the closing element 4. The guide means is preferably made of a plastic.

As can be seen from FIG. 3, the poppet valve 1 according to the invention can be serviced in a very simple manner, in which in a first process step the catcher 3 is detached from the valve body 2, so that the catcher 3 and the guide means 6 connected to it as well as their closing elements 4 can be removed from the valve body 2. Thereupon, if necessary, the valve seat rings 7a can be replaced in a simple manner. In addition, if necessary, the closing elements 4 can be replaced in a simple manner. Moreover, beforehand, if necessary, at least one of the guide means 6, and preferably all guide means 6, can be detached from the catcher 3, and replaced by new guide means 6. Thereupon, the spring 5 is to be inserted into the interior of the guiding means 6, in order to subsequently slip a respective closing element 4 over the corresponding guiding means 6. Thereupon, the valve body 2 and the catcher 3 can be firmly connected to each other again, so that the maintenance of the poppet valve 1 according to the invention is already completed.

In the example shown in FIGS. 1 to 5, the first sliding surface 6g and the second sliding surface 4a are cylindrical. These two sliding surfaces 6a, 4a can also have other shapes, which are designed in such a way that they allow a sliding movement in the stroke direction H. For example, the guide means 6 and the closing means 4 could also have an oval, triangular, square or polygonal cross-section, which form such sliding surfaces 6a, 4a that a sliding movement in stroke direction H is possible.

In one possible embodiment, the closing element 4 could have holes in the area of the guide member 4c in order to achieve a fluid-conducting connection between the interior and exterior of the closing element 4. Such an arrangement can have the advantage that at least temporarily a fluid flow is generated inside the closing element 4 or the guiding means 6, which could remove any dirt deposited.

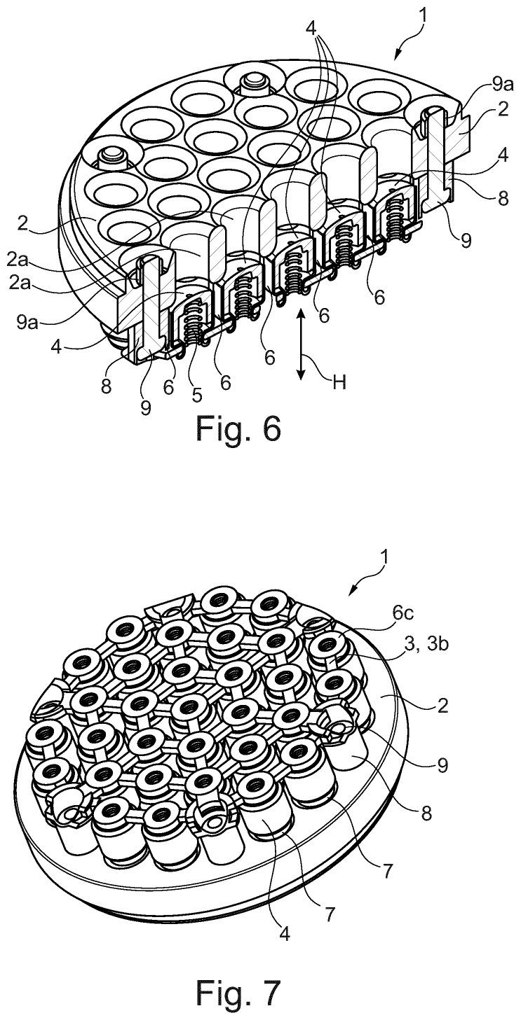

FIG. 6 shows a second embodiment of a poppet valve 1 in a perspective longitudinal section. The poppet valve 1 shown in FIG. 1 and the poppet valve 1 shown in FIG. 6 differ in particular in that the closing elements 4 and the guiding means 6 are designed differently. Otherwise, the two poppet valves are essentially identically designed, at most with the exception of the valve seat 7 and the annular valve seat part 7a.

FIG. 7 shows a bottom view of the poppet valve 1 according to FIG. 6. The catcher 3 is firmly connected to the valve body 2 via a spacer part 8 and a fastening part 9. The guide means 6 are fixedly connected to the catcher 3 via a fastening section 6c, which is designed as a riveted connection comprising a rivet connection part 6i.

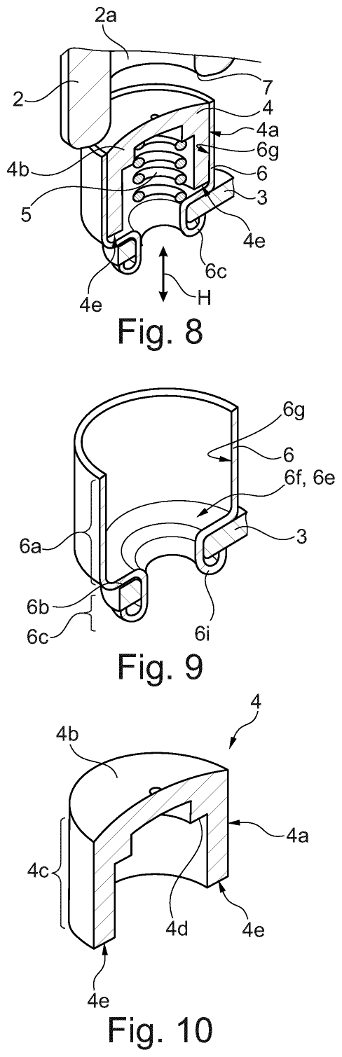

FIG. 8 shows in detail a single closing element 4 as well as the associated guide means 6 and spring 5, and shows the associated passage channel 2a of the valve body 2. In addition, FIG. 8 shows in detail how these are mutually arranged in the poppet valve according to FIG. 6. FIG. 8 shows the same sectional view as shown in FIG. 6. The valve body 2 comprises the passage channel 2a whereby in this embodiment no annular valve seat part 7a is arranged in the valve seat 7. Opposite the valve seat 7 in the stroke direction H is the closing element 4, which is mounted on a guide means 6 so as to be displaceable in the stroke direction H. The closing element 4 is mounted on a guide means 6. As shown in FIG. 10, the closing element 4 consists of a hollow-cylindrical guide member 4c and a closing head 4b, the closing head 4b closing off the inner space enclosed by the guide member 4c towards the valve seat 7. As shown in FIG. 9, the guide means 6 comprises a guide section 6a, a support section 6b and a fastening section 6c. The guide section 6a is hollow cylindrical in shape and has a cylindrical, inwardly oriented first sliding surface 6g. The guide section 4c has a cylindrical, outwardly oriented second sliding surface 4a. As shown in FIG. 8, the guide member 6 encloses the closing element 4 in the circumferential direction, the closing element 4 and the guide means 6 being designed to be identical in such a way that the first sliding surface 6g and the second sliding surface 4a form mutual sliding surfaces along which the closing element 4 is mounted so as to be movable to and fro in the stroke direction H with respect to the guide means 6. The support section 6b forms a first stop surface 6f. The end face of the closing element 4 forms a second stop face 4e. The first and second stop surfaces 6f, 4e are mutually arranged in such a way that they can meet each other during a movement in stroke direction H, thereby limiting the stroke of the closing element 4 in stroke direction H. The guide means 6 is preferably made of metal, and is preferably made of a deep-drawn sheet. If the guide means 6 is made of metal, it preferably has a wall thickness in the range of 0.25 to 1.5 mm, and particularly preferably a wall thickness in the range of 0.3 to 1 mm. The guide means 6 comprises the fastening section 6c, which before assembly is shaped, for example, in the form of a sleeve, so that the fastening section 6c is inserted into the catcher 3 in a first process step, and is then bent over in a second process step, so that the fastening section 6c, as shown in FIGS. 8 and 9, forms a type of riveted joint via which the guide means 6 is fastened to the catcher 3. The bearing surface 6e also forms the first stop surface 6f. The spring 5 is clamped between the first stop surface 6f and the inner surface of the closing head 4b.

The metallic guide means (6) preferably has a wall thickness in the range from 0.25 mm to 1.5 mm, and particularly advantageously a wall thickness in the range from 0.3 mm to 1 mm. The guide means advantageously has a diameter in the range of 8 mm to 15 mm, and particularly advantageously a diameter in the range of 10 to 12 mm. The first stop surface 6f radially to the stroke direction H advantageously has a width that is at least twice as large as the wall thickness of the guide means 6.

The closing element 4 shown in FIG. 10 is preferably made of a plastic, but can also be made of metal.

The valve body 2 could be made of a plastic or of metal. If the closing element 4 is made of plastic, it may be possible to dispense with the annular valve seat part 7a, as shown in FIG. 8, because such closing elements 4 preferably cause only slight wear of the valve seat 7. However, the closing element 4 could also be made of metal. The guide means 6 may be connected to the catcher 3 in a variety of ways. The guide means 6 could also be made of a plastic, and could for example also have an attachment portion 6c with snap-in connection part 6h, as shown in FIGS. 3 and 4, so that the guide means 6 is connectable to the catcher 3 via a clip connection 6c.

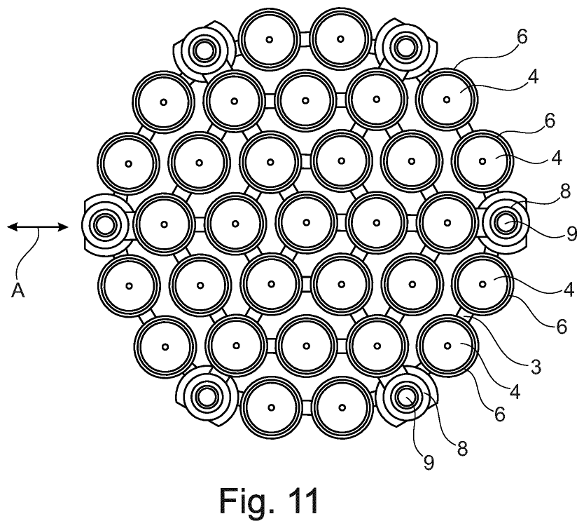

FIG. 11 shows a top view of the poppet valve 1 according to FIG. 6 with the valve body 2 completely removed. The poppet valve 1 comprises a catcher 3 on which 31 guide means 6 are arranged, wherein a closing element 4 with a closing head 4a aligned towards the valve body 2 is arranged in each guide means 6. The arrangement shown in FIG. 11 is firmly and preferably detachably connected to the valve body 2 not shown with the aid of the spacers 8 and the fastening means 9. In an advantageous configuration, the arrangement shown in FIG. 11, if necessary without spacer 8 and fastening means 9, is designed as a preconfigured spare part for the poppet valve 1, so that this only has to be connected to the valve body 2 in order to obtain a poppet valve 1 that is preferably as good as new again by this maintenance measure.

The poppet valve 1 according to the invention can be cost-effectively equipped with a plurality of passage channels 2a and a plurality of closing elements 4. In an advantageous embodiment, the poppet valve 1 comprises along the diameter between 3 to 12 passage channels 2a and closing elements 4, particularly advantageously between 4 to 7 passage channels 2a and closing elements 4. In FIG. 11, five closing elements 4 are arranged along the diameter, in direction A, so that the valve body 2 not shown also has five passage channels 2a. FIG. 11 shows an arrangement with 32 closing elements 4. In an advantageous embodiment, the poppet valve 1 according to the invention has a number of closing elements 4 in the range between 14 and 45, and the same number of passage channels 2a.

The embodiments of poppet valves 1 shown in FIGS. 1 and 6 show embodiments in which the guide means 6 can be connected to the catcher 3, and in which the guide means 6 can advantageously also be disconnected from the catcher 3 again. In a further advantageous embodiment, the guide means 6 form part of the catcher 3, so that the guide means 6 are firmly and inseparably connected to the catcher 3. Such an embodiment has the advantage that during maintenance by replacing the catcher 3 all guiding means 6 are replaced at the same time. In a further advantageous embodiment, a spare part is provided which comprises the catcher 3 as well as all associated guide means 6, closing elements 4 and springs 5. In one possible embodiment, this spare part is designed as a kit in which the individual components still have to be assembled. In a particularly advantageous embodiment, this spare part is already preassembled, so that only the catcher 3 has to be detached from the valve body 2 for maintenance of the poppet valve 1, and that preassembled spare part comprising the catcher 3 as well as the associated guide means 6, closing elements 4 and springs 5 has to be attached to the valve body 2. In this spare part, the guide means 6 may be part of the catcher 3. In another possible embodiment, in this spare part the guide means 6 may be detachably connected to the catcher 3, as shown in FIGS. 1 to 4.

The closing element 4 shown in FIGS. 1 to 5 has an outer diameter in the range of preferably 8 to 14 mm, and particularly advantageously an outer diameter in the range of 10 to 12 mm. The guide means 6 shown in FIGS. 6 to 10 has an inner diameter in the range of preferably 8 to 14 mm, and particularly advantageously an inner diameter in the range of 10 to 12 mm. Advantageously, all closing elements 4 and/or guide means 6 arranged in each case in a poppet valve 1 are identically designed.

1. A poppet valve comprising a valve body with a plurality of passage channels (2a), a plurality of closing elements, a plurality of guide means, and a catcher, wherein each passage channel (2a) opens into a valve seat, wherein a closing element is mounted on each guide means so as to be movable in a stroke direction, wherein a respective closing element is associated with each valve seat opposite in the stroke direction, so that each valve seat can be closed by the respectively associated closing element, wherein each guide means successively comprises in the stroke direction a guide section, a support section and a fastening section, wherein each guide means is connected to the catcher via the fastening section, wherein the guide section comprises an inner cavity extending in the stroke direction, and wherein the support section comprises a bearing surface, wherein a spring extends in the inner cavity of the guide section and is clamped between the support surface and the closing element, and wherein the guide means comprises a single guide section extending in the stroke direction, characterized in that each guide means has a first stop surface oriented toward the valve seat, that each closing element has a second stop surface oriented toward the first stop surface, that the first and second stop surfaces are arranged to cooperate in such a way that they limit the maximum stroke of the closing element in the stroke direction, and in that the fastening section forms a positive connection to the catcher which acts in both directions of the stroke direction.

2. The poppet valve according to claim 1, wherein the catcher has a constant width in the stroke direction.

3. The poppet valve according to claim 2, wherein the catcher is made of a tabular material.

4. The poppet valve according to claim 3, wherein the catcher consists of a metallic sheet.

5. The poppet valve according to claim 1, wherein the guide section is of hollow-cylindrical design and has a first sliding surface extending in the stroke direction, and wherein the closing element has a second sliding surface extending in the stroke direction, wherein the first and the second sliding surfaces are configured in opposite directions, so that each closing element is movably mounted on the associated guide means via the first and second sliding surfaces in the stroke direction.

6. The poppet valve according to claim 5, wherein a cylindrical outer surface of the guide section forms the first sliding surface, and wherein the closing element comprises a hollow cylindrical guide member whose inner surface forms the second sliding surface.

7. The poppet valve according to claim 6, wherein the closing element is designed in one piece and comprises a closing head as well as the hollow-cylindrical guide member extending in the stroke direction adjoining the closing head, the closing head comprising the second stop surface.

8. The poppet valve according to claim 6, wherein the guide section has an end face oriented towards the valve body, which forms the first stop surface.

9. The poppet valve according to claim 6, wherein the closing element is made of a metal.

10. The poppet valve according to claim 9 wherein the closing element has a wall thickness in the range of 0.25 mm to 1.5 mm.

11. The poppet valve according to claim 10, wherein the closing element has a diameter in the range of 8 mm to 15 mm.

12. The poppet valve according to claim 10, wherein the first stop surface has a width radially to the stroke direction which is at least twice as large as the wall thickness of the closing element.

13. The poppet valve according to claim 9, wherein the guide means is made of a plastic.

14. The poppet valve according to claim 13, wherein the fastening section comprises a snap-in connecting part.

15. The poppet valve according to claim 5, wherein an inner surface of the guide section forms the first sliding surface (6g), and wherein the closing element comprises a hollow-cylindrical guide member whose outer surface forms the second sliding surface, so that the closing element is arranged at least partially inside the guide means in the stroke direction.

16. The poppet valve according to claim 12, wherein the closing element is designed in one piece and comprises a closing head as well as the hollow-cylindrical guide member extending in the stroke direction adjoining the closing head, the hollow-cylindrical guide member having an end face facing away from the valve body, which end face comprises the second stop surface.

17. The poppet valve according to claim 12, wherein the guide means, starting from the catcher towards the valve body, comprises first the support section and subsequently the guide section, the support section comprising the first bearing surface oriented towards the valve body.

18. The poppet valve according to claim 12, wherein the guide means is made of a metal.

19.-23. (canceled)

24. The poppet valve according to claim 1, wherein the catcher is designed as a planar lattice structure comprising lattice nodes and struts connecting them, the lattice nodes being designed for fixing the guide means.

25. The poppet valve according to claim 1, designed as a kit comprising the valve body and comprising the catcher with guide means attached thereto, and comprising a plurality of closing elements and springs.
